(19) United States
(12) Patent Application Publication
(10) Pub. No.: US 2022/0176800 A1
(43) Pub. Date: Jun. 9, 2022

(54) Transmission Assembly for a Motor Vehicle and Method for Assembling a Transmission Assembly

(71) Applicant: ZF Friedrichshafen AG, Friedrichshafen (DE)

(72) Inventors: Fabian Kutter, Kressbronn (DE); Stefan Beck, Eriskirch (DE); Uwe Griesmeier, Markdorf (DE); Matthias Horn, Tettnang (DE); Johannes Kaltenbach, Friedrichshafen (DE)

(21) Appl. No.: 17/605,696

(22) PCT Filed: Mar. 4, 2020
(86) PCT No.: PCT/EP2020/055624

§ 371 Date: Oct. 22, 2021

(30) Foreign Application Priority Data
Apr. 23, 2019 (DE) 10 2019 205 758.6

(51) Int. Cl. B60K 6/405; B60K 6/365; B60K 6/547; B60K 6/48

(52) U.S. Cl. CPC B60K 6/405; B60K 6/365; B60K 2006/4808; B60K 6/48; B60K 6/547

(57) ABSTRACT

A transmission arrangement (10) for a motor vehicle includes an electric machine (14) arranged in a first housing part (12). A second housing part (16) is configured for accommodating a component (18) of an internal combustion engine. The electric machine (14) and the internal combustion engine are connectable to an output shaft by a transmission (20). The first and second housing parts (12, 16) are connected to each other and form a common interior space (30). An intermediate wall (34) delimits a subspace (36) from the remaining interior space (30). The electric machine (14) is arranged in the subspace (36). At least one planetary gear set includes at least one element supported at the intermediate wall (34).

### CROSS-REFERENCE TO RELATED APPLICATIONS

The present application is related and has right of priority to German Patent Application No. 102019205758.6 filed in the German Patent Office on Apr. 23, 2019 and is a nationalization of PCT/EP2020/055624 filed in the European Patent Office on Mar. 4, 2020, both of which are incorporated by reference in their entirety for all purposes.

### FIELD OF THE INVENTION

The present application relates generally to a transmission arrangement for a motor vehicle and to a method for assembling a transmission arrangement.

### BACKGROUND

Motor vehicles can have more than one engine or motor. In particular, the combination of at least one electric motor and one internal combustion engine can be advantageous with regard to consumption, environmental protection, and power. For this purpose, however, both the electric motor and the internal combustion engine must be integrated into the drive train of the motor vehicle in order to transmit the particular input power onto the vehicle wheels. For good efficiency, it is advantageous when this integration can also provide various gear stages. For this purpose, a transmission arrangement of a motor vehicle can include at least one transmission, by which the electric motor and the internal combustion engine are connected or are connectable to a drive axle in order to transmit torque.

U.S. Pat. No. 4,507,978 describes, for example, an electric starter, which is connected to a planetary transmission.

### SUMMARY OF THE INVENTION

Example aspects of the present application provide an improved transmission arrangement for a motor vehicle and an improved method for assembling a transmission arrangement.

A first example aspect relates to a transmission arrangement for a motor vehicle. The transmission arrangement can include an electric machine arranged in a first housing part, and a second housing part, which is designed for accommodating a component of an internal combustion engine. The electric machine can form a starter and/or a generator of the motor vehicle, wherein a combination of starter and generator can also be referred to as a starter-generator. The electric machine can also form a hybrid drive of the motor vehicle together with the internal combustion engine, however. Alternatively or additionally, the electric machine can therefore be designed for driving the motor vehicle. The internal combustion engine can be, for example, a gas engine or a diesel engine and can be utilized for driving the motor vehicle and/or for power generation, in particular by the electric machine.

In addition, the transmission arrangement can include a transmission, by which both the electric machine and the internal combustion engine, in particular the component of the internal combustion engine that is arrangeable or arranged in the second housing part, are connectable to an output shaft of the transmission in order to transmit torque. The transmission can be designed for providing particular ratios and/or coupling conditions for an output shaft of the electric machine and an output shaft of the internal combustion engine. For example, a torque can be transmitted from the electric machine to the output shaft at a different ratio than from the internal combustion engine. Similarly, particular coupling conditions and/or ratios can be provided by the transmission for starting the internal combustion engine by the electric machine or for generating power by the internal combustion engine by the electric machine. An optional coupling and decoupling of the electric machine and/or the internal combustion engine can also be provided by the transmission, in order, for example, to be able to drive purely electrically, purely with combustion force, or also in a hybrid mode. The transmission can preferably include one or multiple planetary gear set(s), in particular planetary gear sets coupled and/or nested with one another. A planetary gear set can include, for example, a ring gear, a sun gear, and a planet carrier having one or multiple planet gear(s) retained thereon.

In addition, the transmission arrangement can include an intermediate shaft, which is connected to the output shaft in order to transmit torque and is designed for transmitting a torque to a differential of the motor vehicle and/or a drive axle of the motor vehicle. The intermediate shaft can bridge an axial offset between a main axis of the transmission and of the differential or the axle of the motor vehicle. The differential can also be referred to as a differential gear. The intermediate shaft can therefore be connected to the output shaft of the transmission. In this way, a drive power can be made available at the wheels and/or the drive axle by the internal combustion engine and/or the electric machine. The intermediate shaft is utilized, for example, for enabling an axial offset of the drive axle and/or the differential with respect to the output shaft of the transmission. As a result, the internal combustion engine, the electric machine, and/or the transmission itself can be arranged essentially on a straight line, for example, with the particular centroids and/or main axes of the internal combustion engine, the electric machine, and/or the transmission itself, as the result of which the transmission arrangement can be particularly suitable for a transverse arrangement in the motor vehicle. In a transverse arrangement, a main extension can be essentially parallel to a transverse direction of the motor vehicle.

The two housing parts can be connected to each other, in particular in the installed condition in a motor vehicle. In the connected condition, the two housing parts can form a common interior space, in which the transmission can be arranged. The intermediate shaft can be partially arranged in the interior space. For this purpose, the interior space formed by the two housing parts can have an opening, a recess, and/or a passage, in which the intermediate shaft can be partially or completely arranged. In this way, the intermediate shaft can enable a transmission of power and/or torque from the transmission onto the drive shaft and/or the differential of the motor vehicle.

The transmission arrangement can also include an intermediate wall, which delimits a subspace, in which the electric machine in the interior space is arranged, from the remaining interior space. Therefore, at least two subspaces can be defined by the intermediate wall in the interior space: a first subspace, in which the electric machine is arranged, and a second subspace. The two subspaces can make it possible to set different lube oil conditions therein, in particular despite a common lube oil supply. For example, an amount of oil for cooling the electric machine can be adapted, in a targeted manner, regardless of the amount of oil for cooling and/or lubricating the transmission and/or the component of the internal combustion engine. Completely separate housings can be dispensed with, which possibly need more space and/or more installation effort. A number of sealing points can also be reduced in this way, in particular since the housing can have only one separation point. Preferably, the component of the internal combustion engine is arranged completely in the second subspace. The transmission can be arranged completely in the second subspace or also partially in the first subspace and partially in the second subspace.

Preferably, in addition, the intermediate shaft can be supported at the intermediate wall on the side of the electric machine. The side of the electric machine can be defined as the side facing the electric machine and/or also designated as electric machine-side. Within the scope of this description, a support of a component on the side of the electric machine or of the internal combustion engine can mean that this component is supported with a side of the component that is facing the electric machine or the internal combustion engine, respectively, in particular at a component to be further specified. This support can be axial and/or radial. An electric machine-side end of the intermediate shaft can correspond to an axial end of the intermediate shaft that corresponds to the electric machine. An end on the side of the internal combustion engine can therefore be an opposite end facing the component of the internal combustion engine. The side of the internal combustion engine can be defined as the side facing the internal combustion engine and/or designated as internal combustion engine-side. The intermediate shaft extends axially preferably between the component of the internal combustion engine and the electric machine. The intermediate wall can have a supporting point for this purpose, for example, in the form of a shoulder or a recess. Preferably, the supporting point is designed for arranging and accommodating forces of a bearing. For example, the intermediate shaft can be supported by a roller bearing or an antifriction bearing, in particular an angular roller bearing. An angular tapered roller bearing can also be utilized, for example.

Due to the support of the intermediate shaft at the intermediate wall on the side of the electric machine, additional elements and/or housing parts for providing the supporting point can be dispensed with. In this way, the transmission arrangement can be axially particularly compact. Preferably, an output gear or an output shaft of the transmission is arranged as close as possible in the direction of the internal combustion engine or the component of the internal combustion engine, in order to avoid a long intermediate shaft. Only the installation space necessary for the component of the internal combustion engine must be taken into account. Due to the intermediate wall, the intermediate shaft can be easily arranged radially outside the transmission, which is arranged between the electric machine and the component of the internal combustion engine. In this way, an axial overlap of the transmission and the intermediate shaft can be achieved, with a design that is nevertheless axial and, if necessary, also radially compact. Simultaneously, an additional housing part for the intermediate shaft can be dispensed with. In this way, the assembly is also simple. The intermediate shaft can be arranged radially within the outer diameter of the electric machine, without the need to install the electric machine from a wheel side or a side facing away from the internal combustion engine. A cover on the side of a wheel of the motor vehicle, in particular of a closest wheel of the motor vehicle, for the housing area of the electric machine and installation of the cover is dispensed with. The side of the wheel can be defined as the side situated closest to the wheel or tire and/or also designated as wheel-side. The intermediate wall is positioned after the electric machine has been installed, i.e., at least after the stator has been installed, usually, however, also after the rotor, including any transmission parts, has been installed. With respect to the interior space, for example, only essentially one single housing connecting point, apart from, for example, typical access openings for sensors, supply lines, and the like, namely between the first housing part and the second housing part, must then also be sealed off toward the outside. The axial installation space is optimally utilized, wherein the critical length path is now the electric machine, the intermediate shaft, and the component of the internal combustion engine. The intermediate wall can simultaneously form the supporting point for the intermediate shaft and the interior space cover for the electric machine. Thus, the transmission arrangement can include particularly few parts.

In one further example embodiment of the transmission arrangement, it is provided that the intermediate shaft is supported at a wall of the second housing part on the side of the internal combustion engine. As a result, an additional component for supporting the intermediate shaft does not need to be provided here, either, as the result of which the transmission arrangement is also particularly simple to assemble. In this case as well, the supporting point can include, for example, a shoulder, an indentation, a projection, and/or a passage opening, at which a bearing, such as a tapered roller bearing, can be arranged.

In one further example embodiment of the transmission arrangement, it is provided that the wall, at which the intermediate shaft is supported on the side of the internal combustion engine, delimits a subspace of the interior space for accommodating the component of the internal combustion engine with respect to the interior space. Therefore, a delimitation from the rest of the interior space, in which the transmission and the electric machine are accommodated, can take place here, in order to also be able to subject the component to another oil environment in a targeted manner. The wall can have a passage opening, through which a shaft of the internal combustion engine or the component is connected or can be connected to the transmission. The interior space can therefore also have three subspaces.

Alternatively, the wall, at which the intermediate shaft is supported on the side of the internal combustion engine, can delimit the interior space having the electric machine and the transmission, and the second housing part can at least partially form a second interior space for accommodating the component of the internal combustion engine. The component of the internal combustion engine and also the internal combustion engine itself can then be accommodated, for example, in an interior space of another housing part, which is closed by the wall, at which the intermediate shaft is supported on the side of the internal combustion engine.

In one further example embodiment of the transmission arrangement, it is provided that the transmission arrangement is designed for being arranged in the motor vehicle in the transverse direction with the electric machine on the side of the wheel. As a result, the relatively heavy internal combustion engine can be arranged relatively centrally in the motor vehicle. An arrangement of this type is made possible by the axially short extension due to the intermediate wall having supporting points. The alignment of the transmission arrangement can be defined by particular axes of rotation, in particular the axial direction of the intermediate shaft. For example, the internal combustion engine can be arranged in the center in the machine space, having an electric machine to the left and right thereof with respect to the vehicle, adjacent to the wheel in each case, with a transmission between each electric machine and wheel. Only one electric machine can also be provided, of course. Situated on the side of the wheel, for example, is the end of the transmission arrangement that is closest to a tire or a wheel of the motor vehicle, in particular in the transverse direction. Correspondingly, the intermediate wall can be arranged with respect to the intermediate shaft on the wheel side or the intermediate shaft can be supported at the intermediate wall on the side of the wheel.

In one further example embodiment of the transmission arrangement, it is provided that the intermediate shaft is supported radially at least partially within a stator outer diameter of the electric machine. As a result, a great extent of axial nesting of the transmission arrangement and/or a small amount of necessary axial installation space for the transmission arrangement can be achieved. In addition, the essential radial extension can be limited to the diameter of the electric machine in this way. Preferably, at least the axis of rotation of the intermediate shaft or the central axis is arranged within the diameter of the stator of the electric machine. Therefore, the axis of rotation can also be arranged radially within an outer circumference of the first housing part and, thereby, also the supporting point of the intermediate shaft on the side of the electric machine, which can be advantageous with respect to an oil seal.

In one further example embodiment of the transmission arrangement, it is provided that the first housing part has an assembly opening, through which the electric machine is insertable into and/or removable from the first housing part and this opening is essentially closed by the intermediate wall. This assembly opening can correspond to the opening, in which the intermediate wall is inserted. In particular, the first housing part can have a cup-like shape, which is closed by the intermediate wall. The assembly opening can therefore be made accessible by removing the intermediate wall and can be closed by installing the intermediate wall, similarly to a cover. As a result, a second opening to the first subspace of the interior space defined by the first housing part is not necessary in order to be able to establish a connection to the transmission and also be able to install the electric machine. The electric machine can therefore be installed on or from the side of the internal combustion engine and an interior housing region can be closed by the intermediate wall. Preferably, only this one assembly opening is provided. The intermediate wall, together with the first housing part, can therefore delimit an essentially oil-tight accommodating chamber for the electric machine.

In one further example embodiment of the transmission arrangement, it is provided that the intermediate wall seals with the first housing part and/or the second housing part. For example, the intermediate wall can be sealed off with respect to adjacent areas of a housing part by a seal, such as a sealing ring or a labyrinth sealing, in order to form the different oil chambers. In this way, the transmission can be supplied with a different amount of oil than the electric machine, wherein a common supply, such as a pump and a reservoir, can be utilized.

In one further example embodiment of the transmission arrangement, it is provided that the intermediate wall is attached at the first housing part and/or the second housing part. Preferably, the intermediate wall is detachably attached, as the result of which a simplified assembly of the transmission arrangement can be made possible. For example, the intermediate wall can be bolted to one of the two housing parts. In addition, a recess and/or a shoulder can be provided in the first housing part and/or the second housing part, in or at which the intermediate wall is placed, as the result of which the installation and/or attachment position is predefined. The assembly is simplified as a result thereof as well. The first housing part and the second housing part can be fastened directly to one another or also only indirectly via the intermediate wall. The intermediate wall can also be merely clamped between the two housing parts, as the result of which particularly few mounting parts are necessary.

In one further example embodiment of the transmission arrangement, it is provided that the intermediate wall is essentially arranged in a parting plane between the first housing part and the second housing part. Preferably, the overall housing is separated in a direction transverse to the longitudinal extension, which, in particular, is parallel to the particular axes of rotation, such as the axis of rotation of the intermediate shaft. In other words: The housing is divided into two sections along an axial extension of the housing. Due to the arrangement of the intermediate wall essentially in this parting plane, the housing has only one separation point despite the intermediate wall and, therefore, can be quickly and easily installed. In addition, therefore, only this one separation point is to be sealed. Additional access openings, for example, for sensors, can be sealed separately therefrom, if necessary, or can also be arranged in the separation point.

In one further example embodiment of the transmission arrangement, it is provided that the interior space of the transmission arrangement is essentially delimited only by the first housing part and the second housing part. As a result, the transmission arrangement has particularly few parts and sealing points. In this way, an essentially closed interior space can be easily made available. The transmission arrangement or the housing of the transmission arrangement can therefore be designed to have two shells, which is advantageous with regard to the number of parts and the installation effort. In addition to the two housing parts, the interior space can also be delimited by seals, bolts, and further accessories, wherein, however, a basic shape and structural integrity is predefined by the two housing parts.

Preferably, it is provided with respect to the transmission arrangement that the transmission includes at least one planetary gear set, wherein at least one element of the planetary gear set is supported at the intermediate wall. In particular, the element of the planetary gear set can be supported at the intermediate wall on the side of the electric machine. The element can be, for example, a planet carrier, a ring gear, and/or a sun gear of the planetary gear set. Instead of additionally, only the element of the planetary gear set of the transmission can also, alternatively, be supported at the intermediate wall. The above-described configuration of the intermediate wall and other housing parts can nevertheless be identical or similar to that described above in connection with the support of the intermediate shaft at the intermediate wall, as the result of which similar advantages can result. If the intermediate shaft as well as the element of the planetary gear set of the transmission are supported at the intermediate wall, a synergy results with respect to the compactness of the transmission arrangement and a necessary small number of parts. Multiple elements of the planetary gear set can also be supported at the intermediate wall on the side of the electric machine, in order to enable a great stability of the transmission.

Due to the support of the element of the planetary gear set at the intermediate wall, the transmission arrangement can be particularly compact, in particular in the axial direction. Additional parts for providing the support for the planetary gear set can be dispensed with. The cover for the interior space region of the electric machine can therefore close this as well as provide the supporting point for the transmission. The supporting point can be designed, for example, as a shoulder, a projection, or a passage opening. The passage opening can be closed by the planetary gear set.

The element of the planetary gear set is preferably rotationally fixed to the intermediate wall, for example, by a bolted connection. Usually, at least one element of a planetary gear set is supported in a rotationally fixed manner, which can be particularly easily implemented at the intermediate wall. The element can also be rotatably supported, however, wherein a bearing, such as an antifriction bearing, can then be provided at the supporting point.

Preferably, the element of the planetary gear set is at least radially supported at the intermediate wall. Additionally, the element of the planetary gear set can also be axially supported at the intermediate wall. As a result, axial loads can also be supported in the bearing, as the result of which the planetary gear set can have a particularly simple design. Alternatively, particular axial loads can also be supported in the planetary gear set itself, as the result of which the planetary gear set can be supported in a manner free from axial loads. For this purpose, for example, particular tooth systems can be appropriately aligned, in particular together with a second planetary gear set of the transmission.

Preferably, the transmission has two planetary gear sets, which are preferably connected to each other in order to transmit torque. As a result, a selective coupling and decoupling of the electric machine and the internal combustion engine independently of one another can take place and several different gear stages can be selected for both drives, in order to connect these to the drive train. The two planetary gear sets make this possible with a particularly compact design, in particular an axially compact design when the particular elements are nested. Preferably, an element of that planetary gear set of the two planetary gear sets on the side of the electric machine is then the element that is supported at the intermediate wall. The one planetary gear set that is situated closest to the electric machine can be defined as the planetary gear set on the side of the electric machine. In particular, the two planetary gear sets can be arranged axially next to one another with the particular main axes coaxial, wherein an at least partial axial nesting and/or overlap of the particular extension is also possible for a particularly compact design.

Preferably, the transmission is supported at a wall of the second housing part on the side of the internal combustion engine. As a result thereof as well, additional parts can be dispensed with. In particular, this can be the wall, at which the intermediate shaft can also be supported on the side of the internal combustion engine. In principle, the wall of the second housing part can be described as in the case of the intermediate shaft, even though the intermediate shaft is not supported at this wall on the side of the internal combustion engine. The supporting point for the transmission can be a recess, a shoulder, a projection, and/or a passage opening. The mounting can take place by a bearing or by a rotationally fixed connection, in particular of an element of the second planetary gear set.

In one further example embodiment of the transmission arrangement, it is provided that the component of the internal combustion engine is a clutch, an oil supply device, a system for ensuring uniformity of rotation, such as dual-mass flywheels, a torsional vibration mass damper, a torsional vibration damper, an all-wheel drive divider, and/or a converter transmission. As a result, for example, forces are introduced particularly uniformly into the transmission, as the result of which the intermediate wall must support particularly low loads from the intermediate shaft and/or the planetary gear set.

Particular shift elements of the transmission can preferably also be coupled onto the housing and/or onto the intermediate wall.

A second example aspect relates to a method for assembling a transmission arrangement, in particular a transmission arrangement according to the first example aspect. The features and advantages resulting from the transmission arrangement according to the first example aspect are to be derived from the descriptions of the first example aspect, wherein example embodiments of the first example aspect are to be considered to be example embodiments of the second example aspect, and vice versa.

The method can include at least providing a first housing part. The first housing part preferably has only one assembly opening, which is preferably arranged on the side of the internal combustion engine in the assembled transmission arrangement. In addition, the method can include inserting an electric machine into the first housing part. The electric machine is preferably installed through the assembly opening, i.e., from the side of the internal combustion engine. Access openings on another side, for example, the wheel side when the transmission arrangement is installed in the motor vehicle, can therefore be dispensed with. In addition, the method can include arranging an intermediate wall at the first housing part after inserting the electric machine. The arrangement can also include attaching the intermediate wall, in particular at the first housing part. In particular, initially, at least the stator of the electric machine is inserted before the intermediate wall is arranged and, if necessary, attached, preferably, however, the entire electric machine. The attachment can be preceded by an insertion of the intermediate wall into the first housing part. The attachment can take place, for example, by bolting. Preferably, the intermediate wall closes the assembly opening of the first housing part. The intermediate wall can therefore also be considered to be a cover for the interior space region having the electric machine.

In addition, the method can include supporting an intermediate shaft on the side of the electric machine at the intermediate wall after it has been attached at the first housing part. Alternatively or additionally, the method can also include supporting an element of a planetary gear set at the intermediate wall on the side of the electric machine after it has been attached at the first housing part. An additional housing and/or connecting elements for supporting the planetary gear set and/or the intermediate shaft can therefore be dispensed with.

In addition, the method can include attaching a second housing part, which is designed for accommodating a component of an internal combustion engine, at the first housing part and/or the intermediate wall while forming an interior space. Preferably, the intermediate shaft and/or an element of the planetary gear set of the transmission are/is supported at a wall of the second housing part on the side of the internal combustion engine. Preferably, the second housing part is attached only after the intermediate shaft and/or the transmission have/has been arranged at the intermediate wall and/or supported thereon.

In addition, the method can include arranging a transmission in the interior space. This transmission can be the above-described transmission including the planetary gear set. Preferably, the transmission is arranged at the intermediate wall before the second housing part is installed. In this way, a complete assembly of the transmission arrangement from the side of the machine is possible.

The assembly can therefore take place continuously from a starting point aligned, in the installation position, from the side of the wheel, exclusively in the direction of the internal combustion engine, wherein only two housing parts are needed for closing a transmission interior, which are to be sealed toward the outside.

In addition, the method can include, furthermore, arranging a component of the internal combustion engine at or in the second housing part, wherein this is also preferably installed from the internal combustion engine side.

The method is particularly simple, since installation can take place only from one direction. In addition, fewer parts, connections, and seals are needed, which also simplifies the assembly.

A further example aspect relates to a motor vehicle including the transmission arrangement according to the first example aspect. The transmission arrangement is preferably designed as a front-mounted transverse transmission arrangement. Therefore, the transmission arrangement can be arranged in the motor vehicle at the front in the transverse direction. The features and advantages resulting from the transmission arrangement according to the first example aspect are to be derived from the descriptions of the first example aspect, wherein example embodiments of the first example aspect are to be considered to be example embodiments of the further example aspect, and vice versa.

Further features result from the claims, the exemplary embodiment, and on the basis of the drawings. The features and combinations of features mentioned above in the description as well as the features and combinations of features mentioned in the following in the exemplary embodiments are usable not only in the particular described combination, but rather also in other combinations, without departing from the scope.

### BRIEF DESCRIPTION OF THE DRAWING

FIG. 1 shows a transmission arrangement according to an example embodiment in a diagrammatic sectional view.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

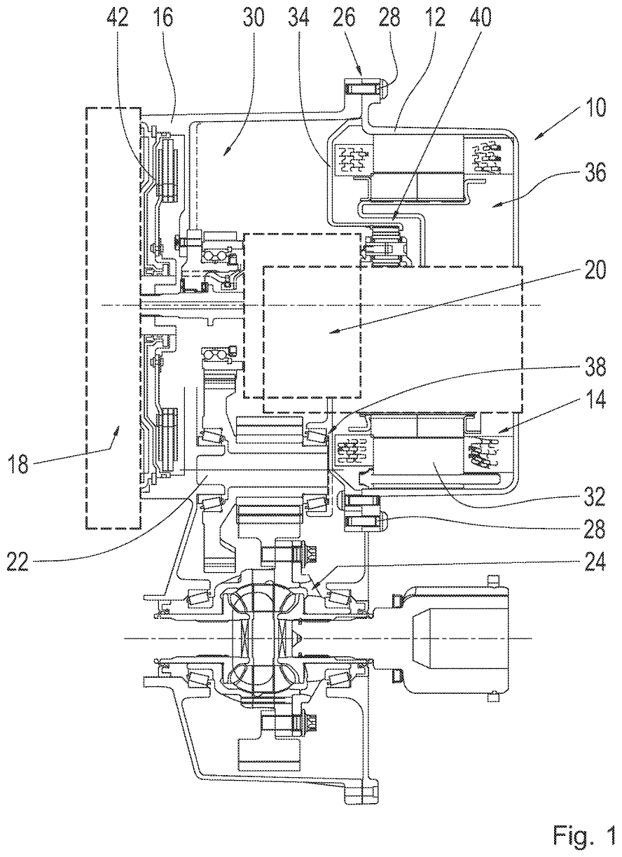

FIG. 1 shows a transmission arrangement 10 for a motor vehicle, which includes an electric machine 14 arranged in a first housing part 12, wherein the electric machine 14 can also be referred to as an electric motor 14. In addition, the transmission arrangement 10 includes a second housing part 16, in which a component 18 of an internal combustion engine is accommodated. In the present case, the component 18 can be, for example, a clutch, an oil supply device, a system for ensuring uniformity of rotation, such as dual-mass flywheels, a torsional vibration mass damper and/or a torsional vibration damper.

In addition, the transmission arrangement 10 includes a transmission 20, by which the electric machine 14 and the internal combustion engine, in particular the component 18, are connectable to an output shaft of the transmission 20 for transmitting torque with differently settable transmission ratios and/or gear stages. Selectively engageable gear stages can also be referred to as gears. The transmission 20 can also be referred to as a main transmission. The transmission 20 can include, for example, two planetary gear sets, by which the electric machine 14 and the internal combustion engine are connected to the drive train with transmission ratios that are settable largely independently of one another, in order to transmit torque. Therefore, multiple electric gears and internal combustion engine-gears are available for a particularly efficient power coupling. For this purpose, the transmission 20 can include particular shift elements in order to couple, in each case, different elements of the planetary gear sets to one another in a rotationally fixed manner. For example, a planet carrier of one of the two planetary gear sets adjacent to the component 18 can function as the output shaft. A sun gear or a ring gear can also function as the output shaft, however. In addition, the transmission 20 can also include particular clutches in order to interrupt the torque transmission of the electric machine 14 and/or of the internal combustion engine or the component 18.

In addition, the transmission arrangement includes an intermediate shaft 22, which is connected to the output shaft of the transmission 20 in order to transmit torque and is designed for transmitting a torque to a differential 24 of the motor vehicle. The differential 24 is connected to a drive axle of the motor vehicle, and so particular torques generated by the internal combustion engine and/or the electric machine can be utilized for driving the motor vehicle.

The two housing parts 12, 16 are connected to each other at a separation point 26, in the present case by particular bolted connections 28. The separation point 26 is to be understood to be a circumferential separation. The two housing parts 12, 16 therefore form two halves of a two-shelled housing. As is apparent, the two shells or two housing parts 12, 16 form a parting plane, which is essentially orthogonal with respect to particular axes of rotation of the transmission 20 and also of the intermediate shaft 22. In this way, the interior space 30 can be particularly easily sealed, in particular in comparison to a housing having more housing parts and/or assembly openings and covers. The axes of rotation correspond to an axial extension of the transmission arrangement 10 and of the transmission 20. The radial extension is orthogonal in relation thereto.

The two housing parts 12, 16, together, form an interior space 30. The transmission 20 and the electric machine 14 are arranged in the interior space 30. The intermediate shaft 22, at least with an axis of rotation of the intermediate shaft 22, is also arranged radially within the interior space 30, as the result of which the transmission arrangement 10 is particularly compact. The radial position of the axis of rotation of the intermediate shaft 22 is therefore also located within the outer diameter of a stator 32 of the electric machine 14.

In addition, the transmission arrangement also includes an intermediate wall 34, which delimits a subspace 36, in which the electric machine in the interior space 30 is arranged, from the remaining interior space 30. As a result, despite a shared oil supply, a separate adjustment of the amount of oil for the transmission 20 and for the electric machine 14 is possible. A portion of the transmission 20 can also be arranged in the subspace 36, however, and supplied with oil there together with the electric machine 14. A nearly complete separation is also possible, however.

In addition, the first housing part 12 forms a cup-like structure, which, in FIG. 1, delimits the interior space 30 or the subspace 36 toward the right. Toward the right is a side facing away from the internal combustion engine and facing a wheel of the motor vehicle in the case of a transverse installation. A transverse installation is an installation position of the transmission arrangement 10, in which the transmission arrangement 10 extends with a main axis of the transmission arrangement 10 essentially parallel to the transverse direction and/or an axle of the motor vehicle. As a result, due to the intermediate wall 34 and due to the position of the intermediate shaft 22, the electric machine 14, in particular a stator 32 of the electric machine 14, can be installed from the side of the internal combustion engine and an additional assembly opening is not necessary on the side of the wheel.

Due to the arrangement of the intermediate wall 34 essentially in the parting plane of the housing, the intermediate wall 34 can be quickly and easily installed, for example, by being bolted together with the first housing part 12. After the insertion of the electric machine 14, the intermediate wall 34 can also be inserted into the assembly opening of the first housing part 12 and, thereby, fix the electric machine in the first housing part 12. As a result, the assembly is particularly simple.

Finally, the intermediate shaft 22 and the transmission 20 can be inserted into the interior space 30. The intermediate shaft 22 is supported at the intermediate wall 34 on the side of the electric machine 14. The supporting point 38 is formed by two projections, at which an angular tapered roller bearing is arranged. As a result, the intermediate shaft 22 can be supported there axially as well as radially. Due to the mounting of the intermediate shaft 22 at the intermediate wall 34 on the side of the electric machine 14, the transmission arrangement 10 can be particularly well nested and, thereby, axially compact. Simultaneously, additional housing parts for support can be dispensed with.

An element of the transmission 20 is also supported at the intermediate wall 34 on the side of the electric machine 14. The supporting point 40 for the transmission 20 forms, here, a recess in the intermediate wall 34, which can also be designed as a passage opening for connecting the transmission 20 to a rotor of the electric machine 14. In the present case, a planet carrier of a planetary gear set facing the electric machine 14 is rotationally fixed to the intermediate wall 34. As a result, an axial as well as radial support is provided. Alternatively, the transmission 20 can also be only radially supported at the supporting point 40 and, for the rest, designed in such a way that the transmission 20 itself absorbs axial loads. Alternatively or additionally, particular other elements, such as a sun gear or a ring gear of the transmission 20, could also be supported at the intermediate wall 34. In the present case, the planet carrier is supported, since the planet carrier, in the case of the transmission 20, is to be fixedly coupled to the housing and is not rotatable. Therefore, the support can be particularly simple. In addition, the non-rotating planet carrier can easily seal a passage opening in the intermediate wall 34 at least to the extent that the subspace 36 can be supplied with a different amount of oil than the rest of the interior space 30. Due, as well, to the support of the element of the transmission 20 at the intermediate wall 34 on the side of the electric machine 14, the transmission arrangement 10 can be particularly well nested and, thereby, axially compact. Simultaneously, additional housing parts for support can be dispensed with.

On the side of the internal combustion engine, i.e., facing away from the electric machine 14 and the wheel side, the second housing part 16 has a wall 42, which, similarly to the intermediate wall 34, protrudes into the interior space 30. This is the side on the left in FIG. 1. This wall 42 can further subdivide the interior space 30, namely into a separate subspace for the component 18. As a result, another amount of oil can also be set with respect to this component 18. The wall 42 can also be understood, however, to be the part of the housing part 16 that delimits the interior space 30. In this case, the component 18 is therefore not arranged in the interior space 30.

The wall 42 can be utilized for supporting the component 18. In addition, the wall 42, similarly to the intermediate wall 34, can also provide the support of the intermediate shaft and the transmission at the particular side facing the internal combustion engine and the component 18. As shown, the intermediate shaft 22 is also supported on the side of the internal combustion engine with an angular tapered roller bearing at particular projections of the wall 42. The transmission 20 can also be supported at the wall 42 with a shaft that protrudes through the wall 42.

As a result thereof as well, the number of necessary housing parts can be very low. In addition, the assembly is simplified in this way. Due to the separate intermediate wall 34, the electric machine 14 can be installed from the side of the internal combustion engine in the first housing part 12 and fixed there with the separate intermediate wall 34. The intermediate wall 34 is preferably detachably attached. Finally, the transmission 20 and the intermediate shaft 22 can be arranged at the intermediate wall 34 and then automatically fixed in the interior space 30 between the two housing parts 12, 16 by connecting the second housing part 16 with the first housing part 12. An additional fixing or further assembly, apart from particular supports, is therefore not necessary. The transmission 20 and the intermediate shaft 22 are therefore clamped, for all intents and purposes, between the two housing parts 12, 16.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 transmission arrangement
12 first housing part
14 electric machine
16 second housing part
18 component of an internal combustion engine
20 transmission
22 intermediate shaft
24 differential
26 separation point
28 threaded connection
30 interior space
32 stator
34 intermediate wall
36 subspace
38 supporting point of the intermediate shaft
40 supporting point of the transmission
42 wall

1-15. (canceled)

16. A transmission arrangement (10) for a motor vehicle, comprising:
a first housing part;
an electric machine (14) arranged in the first housing part (12);
a second housing part (16) configured for accommodating a component (18) of an internal combustion engine;
a transmission (20), the electric machine (14) and the component (18) of the internal combustion engine connectable to an output shaft of the transmission (20) in order to transmit torque, the first and second housing parts (12, 16) connected to each other and forming a common interior space (30) in which the transmission (20) is arranged; and
an intermediate wall (34) delimiting a subspace (36) from the remaining interior space (30), the electric machine (14) arranged in the subspace (36),
wherein the transmission (20) comprises a planetary gear set, at least one element of the planetary gear set supported at the intermediate wall (34).

17. The transmission arrangement (10) of claim 16, wherein another element of the planetary gear set is supported at a wall (42) of the second housing part (16) on a side of the internal combustion engine.

18. The transmission arrangement (10) of claim 17, wherein:
the wall (42) delimits another subspace of the interior space (30) for accommodating the component (18) of the internal combustion engine with respect to the interior space (30); or
the wall (42) delimits the interior space (30) having the electric machine (14) and the transmission (20), and the second housing part (16) at least partially forms a second interior space for accommodating the component (18) of the internal combustion engine.

19. The transmission arrangement (10) of claim 16, wherein the transmission arrangement (10) is arrangeable in the motor vehicle in a transverse direction with the electric machine (14) on a side of a closest wheel of the motor vehicle.

20. The transmission arrangement (10) of claim 16, further comprising an intermediate shaft (22) connected to the output shaft in order to transmit torque and configured for transmitting a torque to one or both of a differential (24) and a drive axle of the motor vehicle, wherein the intermediate shaft (22) is at least partially arranged in the common interior space (30), and the intermediate shaft (22) is supported at the intermediate wall (34) on a side of the electric machine (14).

21. The transmission arrangement (10) of claim 20, wherein the intermediate shaft (22) is supported radially at least partially within a stator outer diameter of the electric machine (14).

22. The transmission arrangement (10) of claim 16, wherein the first housing part (12) defines an assembly opening, the electric machine (14) insertable into and/or removable from the first housing part through the assembly opening, and the assembly opening is essentially closed by the intermediate wall (34).

23. The transmission arrangement (10) of claim 16, wherein the intermediate wall (34) seals with one or both of the first housing part (12) and the second housing part (16).

24. The transmission arrangement (10) of claim 16, wherein the intermediate wall (34) is removably attached at one or both of the first housing part (12) and the second housing part (16).

25. The transmission arrangement (10) of claim 16, wherein the intermediate wall (34) is arranged essentially in a parting plane (26) between the first housing part (12) and the second housing part (16).

26. The transmission arrangement (10) of claim 16, wherein the interior space (30) of the transmission arrangement (10) is delimited essentially only by the first housing part (12) and the second housing part (16).

27. The transmission arrangement (10) of claim 26, wherein the at least one element of the planetary gear set is rotationally fixed to the intermediate wall.

28. The transmission arrangement (10) of claim 26, further comprising another planetary gear set such that the transmission arrangement (10) comprises two planetary gear sets, wherein an element of the one of the two planetary gear set on a side of the electric machine (14) is the element that is supported at the intermediate wall.

29. The transmission arrangement (10) of claim 16, wherein the component (18) of the internal combustion engine comprises one or more of a clutch, an oil supply device, a dual-mass flywheel, a torsional vibration mass damper, a torsional vibration damper, an all-wheel drive divider, and a converter transmission.

30. A method for assembling the transmission arrangement (10) of claim 16, comprising:
providing the first housing part (12) with only one assembly opening;
inserting the electric machine (14) into the first housing part (12) through the assembly opening;
arranging the intermediate wall (34) at the first housing part (12) after inserting the electric machine (14) and the assembly opening is closed;
supporting the element of a planetary gear set of the transmission at the intermediate wall (34) on a side of the electric machine (14) after arranging the intermediate wall (34) at the first housing part (12); and
attaching the second housing part (16), which is configured for accommodating the component (18) of the internal combustion engine, at one or both of the first housing part (12) and the intermediate wall (34) while forming the interior space (30) with the transmission (20) at least partially accommodated within the interior space (30).

31. The method of claim 30, wherein the element of the planetary gear set is supported at a wall (42) of the second housing part (16) on a side of the internal combustion engine.
